(19) United States
(12) Patent Application Publication
(10) Pub. No.: US 2020/0117730 A1
(43) Pub. Date: Apr. 16, 2020

(54) DATABASE MANAGEMENT

(71) Applicant: Microsoft Technology Licensing, LLC, Redmond, WA (US)

(72) Inventors: Kapil VASWANI, Cambridge (GB); Manuel COSTA, Cambridge (GB); Mark RUSSINOVICH, Redmond, WA (US)

(21) Appl. No.: 16/162,269

(22) Filed: Oct. 16, 2018

(51) Int. Cl. G06F 17/30; G06F 21/62; H04L 9/06; H04L 9/32

(52) U.S. Cl. CPC G06F 17/30368; G06F 17/30371; H04L 9/3247; H04L 9/0637; G06F 21/6227

(57) ABSTRACT

A database management system (DBMS) comprises one or more transaction processing engines (such as SQL engines) configured to execute a series of database transactions, each being executed according to one or more commands received in at least one transaction execution message so as to cause a change of state of the database from a previous state to a new state. The DBMS is configured to generate a series of transaction log records and provide the series of transaction log records to a blockchain network for storing in a blockchain secured by the blockchain network. Each transaction log record corresponds to one of the database transactions and comprises (i) the one or more commands according to which it was executed and (ii) results of its execution. The series of transaction log records constitutes an immutable audit log from which database is fully recoverable for auditing purposes.

### TECHNICAL FIELD

The present disclosure relates to database management technology.

### BACKGROUND

Conventional database systems, for example those providing shared access to a database by multiple users, often rely upon a trusted third party, for example a database administrator, to administer access permissions and other configuration aspects relating to the database. Transactions requested by users for execution in or in respect of the database are therefore subject to any constraints applied through configuration settings applied by the database administrator. An audit log may be maintained by the database system, recording particular details of user activity in accessing the database. The configuration settings usually determine what is recorded in the audit log. The database administrator may access the audit log for management purposes, for example to perform analysis of log records, for archiving purposes or to invoke any applicable data retention policy.

The database may be a relational database for which transactions are defined using a database management programming language such as SQL (Structured Query Language). SQL is a standard language for managing data within a relational database management system (RDBMS). Database-related operations are instigated by way of commands in the form of SQL statements submitted to a message interface or SQL ‘front-end’. SQL is a comprehensive language encompassing a range of functions including data querying, data manipulation, data definition and data control. SQL provide a comprehensive framework for accessing and manipulating different forms of relational database.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

According to a first aspect disclosed herein, a database system comprises computer readable storage media, one or more processors having access to the computer readable storage media and configured to execute a database management system (DBMS) for managing a database embodied in the computer readable storage media, and at least one computer interface configured to receive transaction execution messages relating to the database. The DBMS comprises one or more transaction processing engines configured to execute a series of database transactions, each being executed according to one or more commands received in at least one transaction execution message so as to cause a change of state of the database from a previous state to a new state. The DBMS is configured to generate a series of transaction log records and provide the series of transaction log records to a blockchain network for storing in a blockchain secured by the blockchain network. Each transaction log record corresponds to one of the database transactions and comprises (i) the one or more commands according to which it was executed and (ii) results of its execution, such that the new state of the database is recoverable from that transaction log record and the previous state of the database, whereby the database is fully recoverable from the series of transaction log records stored in the blockchain.

The series of transaction log records in the blockchain constitutes an immutable audit log from which the database can be fully or partially reconstructed for auditing purposes. Such an audit log can be used to achieve non-equivocation, an integrity property which implies the database cannot disguise transactions that it has previously executed and committed to the audit log even if the database has been entirely or partially compromised. With the present technology, non-equivocation and robust auditability can be achieved with minimal modifications to an existing DBMS without any significant impact on its native performance.

### BRIEF DESCRIPTION OF THE DRAWINGS

To assist understanding of the present disclosure and to show how embodiments may be put into effect, reference is made by way of example to the accompanying schematic drawings in which:

FIG. 1 shows an example of a high-level RDBMS architecture;

FIG. 2 shows an example of a RDBMS interfacing with an independent blockchain network;

FIG. 3 shows an example of a distributed database system;

FIG. 4 shows an example set of transaction log records;

FIG. 5 shows an example blockchain data structure that is secured by a blockchain network based on trusted hardware; and

FIG. 6 shows a signaling flow for an example transaction validation process.

### DETAILED DESCRIPTION

In the described examples, a database is extended with a tamper proof audit log stored in a blockchain. As noted, such an audit log can be used to achieve non-equivocation, an integrity property which implies that a database cannot disguise transactions that it has previously executed and committed to the audit log even if the entire database has been compromised. The audit log is formed of a series of transaction log records corresponding to a series of database transactions executed on the database. Each transaction log record contains sufficient details of the corresponding database transaction such that the database is fully recoverable from the series of transaction log records. This allows a replica of the database to be fully or partially reconstructed from the transaction log records as appropriate for the purposes of auditing, for example to detect tampering with the original database. In some cases, the blockchain containing the log of database transactions may be the only representation of the database and the state required to execute each transaction may be reconstructed from the blockchain only when it is needed to execute a transaction.

In the described examples, the database is a relational database and a relational database management system (RDBMS) is provided with an interface to an independent blockchain network that operates to maintain and secure the blockchain.

A relational or other database management system (DBMS) refers to a computer program or set of computer programs for creating and managing databases. The DBMS is executed on one or more processors (such as CPUs, GPUs, accelerators etc.) of a database system. A DBMS allows users and applications to interact with a database managed by the DBMS to perform operations such as data creation, manipulation, querying and control, as well as database administration.

An SQL front-end is also provided for receiving transaction execution messages from clients. Database transactions are executed according to commands received in transaction execution messages at the SQL front-end. The commands are text-based commands in the form of SQL statements and the transaction execution messages may be referred to in this context as SQL queries. The term SQL text may be used herein to refer to one or more SQL statements comprised in a transaction execution message generated by client and submitted to the RDBMS for processing.

For various reasons a database transaction might be aborted or fail. In some cases, aborted/failed transactions are also recorded in the blockchain.

The RDBMS manages the database and comprises at least one transaction processing engine for executing database transactions on the database. In the examples described below, a plurality of transaction processing engines, such as SQL engines, are provided in a distributed processing arrangement. These may be distributed backcross two or more computer systems operated by different enterprises or other mutually untrusted entities. The transaction processing engines operate in conjunction to provide a single (logical) database server accessed via the SQL front-end. The transaction processing engines may be referred to as server instances in that context.

The RDBMS is extended to push transaction log records to the blockchain network for storing in the blockchain. Each transaction log record records includes the full text of the corresponding SQL query along with results generated in response to that query by the database server. The text of the query is cryptographically signed by a client which issued the query. The results may also be cryptographically signed by the database server.

Database transactions can be written to the blockchain synchronously, e.g. as part of a commit protocol implemented by the RDBMS, or asynchronously, e.g. in a batch process. In the case where the changes are written to the blockchain as part of the commit protocol, the RDMBS may optionally be configured to only commit the transaction locally if the blockchain also commits the transaction. For example, the RDBMS may run a two-phase commit protocol with the blockchain. As part of committing the transaction to the blockchain, some blockchains may be configured to replicate the transaction to at least one other RDBMS and these blockchains may decide to only commit the transaction if all the RDBMS(s) involved accept to commit the transaction.

The blockchain network can have any suitable blockchain architecture that allows the blockchain to be secured (e.g. based on proof-of-work, byzantine fault-tolerant replication, etc.). However, in the described examples, the architecture is based on trusted hardware (see below). With a trusted hardware architecture, the blockchain network cryptographically signs the log records to be stored in the blockchain as part of the process of securing the blockchain. The cryptographic processing that is performed to sign a transaction log record takes place within a trusted execution environment (TEE) of the blockchain network, and uses a private key which is stored in secure storage of the TEE and which is not accessible to privileged attackers such as a database administrator or hackers who may have compromised the database server. This provides tamper proof database audit logs using trusted hardware.

Each signed log records serves as a proof that the corresponding database transaction was executed by the database server. Since the blockchain is immutable, clients are guaranteed that the database cannot equivocate on transactions once they have been written to the blockchain.

The blockchain network operates independently of the RDBMS, with only a loose coupling between the database server and the independent blockchain network. As noted, a benefit of this loose coupling is that the database can be run mostly unmodified, with close to native performance, whilst still advantageously leveraging the immutability of the supporting blockchain to achieve non-equivocation and full auditability.

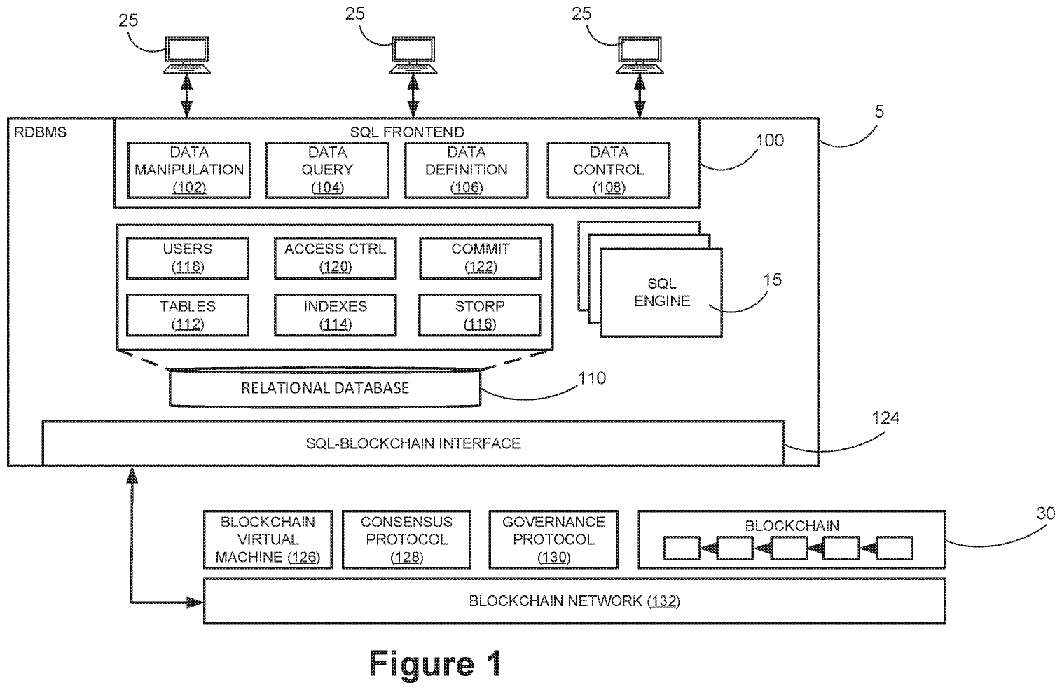

An example SQL-blockchain hybrid architecture that can achieve this will now be described with reference to FIG. 1.

Referring to FIG. 1, there is shown a highly schematic system block diagram illustrating certain principles of the described technology. An RDBMS 5 is shown as having an SQL front-end 100 to which clients 25 can submit inputs formed of SQL statements. The SQL front-end 100 accepts and processes such inputs to allow the clients 25 to instigate database transactions relating to a relational database (DB) 110. The SQL front-end is provided by one or more SQL engines 15. For example, multiple SQL engines 15 may be provided in a server cluster or other distributed processing arrangement that can provide distributed database functions.

The database has a set of defined users 118 who may be authorized to perform operations on the DB 110, in accordance with at least one access control policy 120.

The SQL front-end 100 is shown to comprise a data manipulation component 102, a data query component 104, a data definition component 106 and a data control component 108. As will be appreciated, these are a high level representations of particular classes of function provided by the SQL engines 15 as part of the SQL front-end 100, and which, despite being shown as distinct components, might have a degree of overlap.

Data definition 106 refers to the creation and modification of a database schema which defines data structures embodied in the DB 100. The data structures may comprise tables 112 (relations) and related components such as indexes 114 for the database 110 and stored procedures 116 (STORPs) which are stored in a database dictionary and can be applied to the DB 110 by users 118/clients 25 who are authorized to do so. Data manipulation 102 refers to the storing, deletion and modification of data within tables 112 and/or other such data structures of the DB 110. Data querying refers to the querying of the DB 110 to obtain desired data. Data control refers to functions relating to the access control policy 120 which, in turn, defines which users 118 can carry out query, manipulation and control operations in respect of which data. This may for example be supported by permissions, roles etc. associated with database users 118. Data control operations can be performed to effect access control changes, such as creating new or modifying existing permissions, roles etc.

Additionally, a SQL-blockchain interface layer 124 is provided, via which blockchain functions can be instigated to support the core functions of the RDBMS 5.

The blockchain functions are provided by an independent blockchain network 132 which can take various forms. A core function of the blockchain network 132 is to provide distributed data storage in which a blockchain 30 is stored and which is immutable in that it is secured using a reliable consensus protocol 128 of the blockchain network 132. Whilst the specifics can vary between different blockchain networks, a typical modern blockchain network implements a blockchain virtual machine (VM) 126 (such as the Ethereum virtual machine) on which computer programs referred to as “smart contracts” can be executed. Smart contracts are computer programs coded in a byte code of the blockchain VM 126. Transactions are submitted to the blockchain network 132 and validated within the blockchain network. Valid transactions are stored in the blockchain 30, in accordance with the consensus protocol 128. The blockchain 30 has a state which is defined by the sequence of transactions it contains together with a state transition function for validating blockchain transactions and updating the blockchain state in response to valid blockchain transactions.

The blockchain network can be any form of blockchain network, including public blockchain networks of the kind in use today (e.g. Ethereum etc.). However, in some contexts at least, it may be preferable to use a blockchain network designed using trusted hardware. By way of example, a CoCo (Confidential Consortium) Framework for enterprise blockchain networks by Microsoft® provides a trusted foundation that delivers efficient consensus algorithms and flexible confidentiality schemes, and which can support new and existing blockchain protocols (such as Ethereum, Quorum, Corda etc.) with enhanced latency, throughput and confidentiality safeguards. By way of example, reference is made in this context to United States Patent Publication No. US 2018/0225661 A1 and additionally to the publically-available CoCo whitepaper (“The CoCo Framework—Technical Overview”, published 10 Aug. 2017; https://github.com/Azure/coco-framework/blob/master/docs/Coco%20Framework%20whitepaper.pdf), each of which is incorporated herein by reference in its entirety.

Whilst traditional blockchain protocols are generally based on a “proof of work” requirement, different forms of consensus protocol (with or without proof of work) can be used in the present context to secure the blockchain 30. By way of example, the above-referenced CoCo framework can support efficient Paxos or Caesar consensus protocols (among others). As noted above, with a trusted hardware implementation, the blockchain itself is secured using public-private key cryptography, wherein valid transactions to be added to the blockchain are cryptographically signed within TEEs provided by the trusted hardware.

Certain types of blockchain network, such as consortium networks, also operate according to a distributed governance protocol 130, which may for example define which blockchain users are authorized to submit transactions to the blockchain network 124 and which users are allowed to access the blockchain 30. With regards to the latter, whilst certain public blockchains store data in plaintext which can be accessed by any user, confidential/consortium networks based on trusted execution hardware allow the blockchain data to be encrypted with access regulated via trusted execution environment (TEEs) provided by the trusted hardware. Other blockchain architectures may also be used to provide a closed, i.e. encrypted or partially encrypted, blockchain to which access can be regulated in accordance with a governance protocol.

An aspect of SQL is the ability to “commit” database transactions for execution in, or in respect of a database, typically by way of a commit statement that is submitted in association with one or more operational statements, such as data query, data access, data control, data manipulation statements or any combination thereof (although “commit” may be implicit for certain operational statements). When a database transaction is committed then, assuming it is valid, the statements contained therein are executed in respect of the DB 110 such that the results become visible to other users. Database statements are committed in accordance with a commit protocol 122 (commit logic) associated with the DB 110. This may be referred to herein as a committed database transaction.

In the RDBMS 5, committed database transactions—of any type—may be recorded in log records stored in the blockchain 30, such that the current state of the blockchain 30 provides an immutable record of a current state of the DB 110. This allows the structure and content of the DB 110, and its related policies, permissions, user definitions etc. (i.e. any aspect of or relating to the DB 110 that is controlled by committed database transactions) to be reconstructed from the immutable blockchain 30.

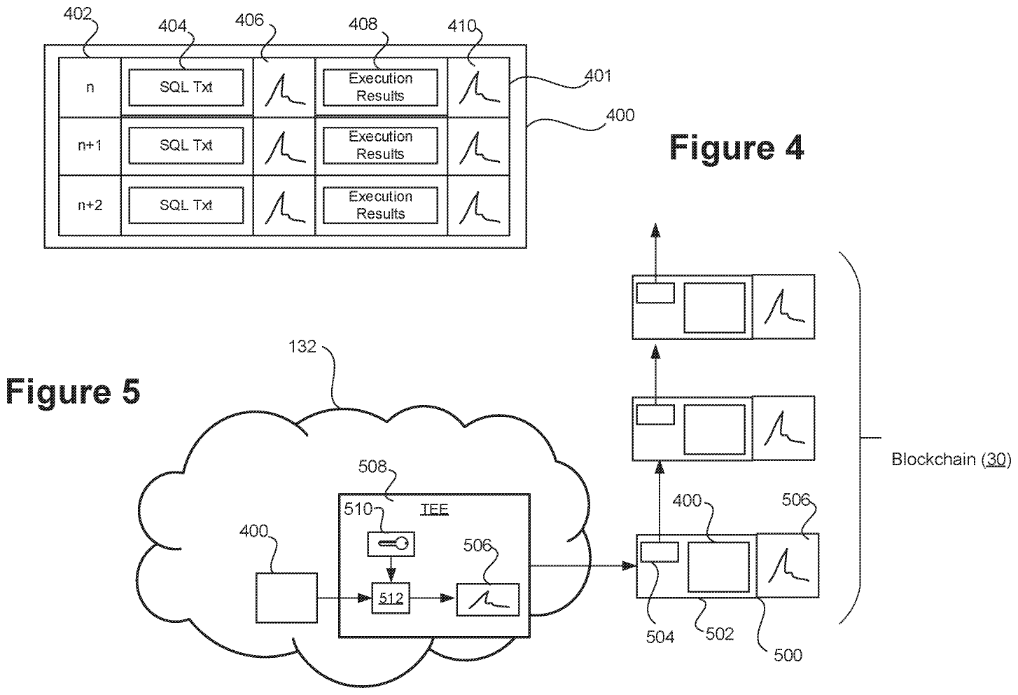

Note, herein a distinction is drawn between “database/SQL transactions” which are executed by the SQL engines 15 according to SQL statements received at the SQL-front end 100, and “blockchain transactions” which submitted to the blockchain network 132 for validation and storing in the blockchain. Where the term “transaction” is used, it will be clear in context what is meant. In the present context, a blockchain transaction submitted to the blockchain network 132 by the RDBMS 5 may comprise one or multiple transaction log records (corresponding to one or multiple database transactions) to be stored in the blockchain 30. Further examples of this are described later with reference to FIGS. 4 and 5.

The transaction log records include the full text of each committed SQL query/statement signed by the client 25 issuing the query/statement, along with results generated by the SQL engine 15 which processed that query/statement. Transactions can be written to the blockchain 30 either synchronously (as part of a commit protocol of the RDBMS), or asynchronously. Optionally a transaction log record may also include a set of any writes (insert, updates, and deletes) made to the data in the DB 110 during transaction execution.

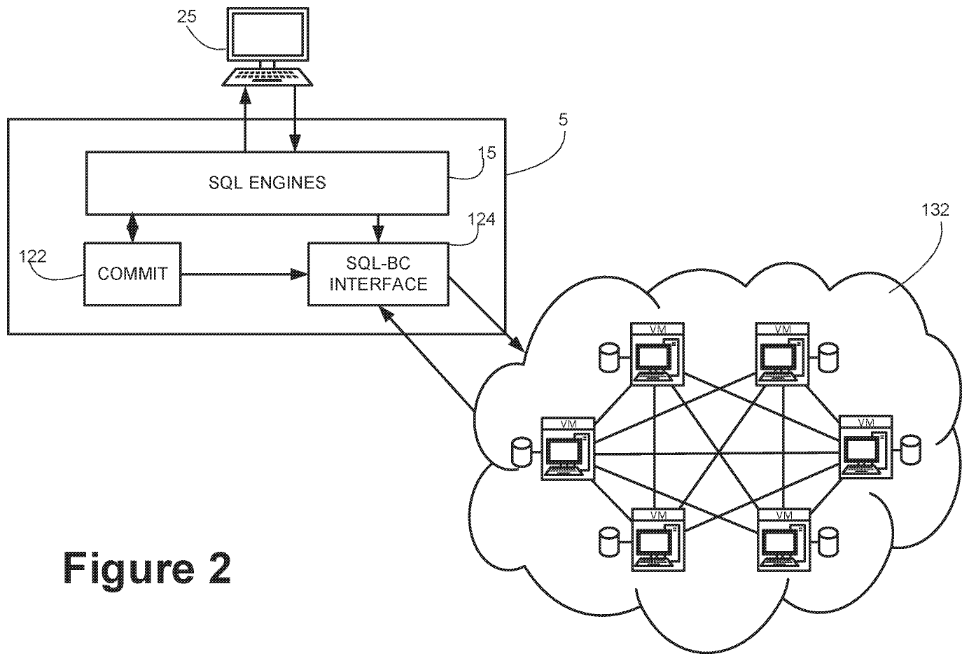

FIG. 2 shows an example architecture in which the above principles may be implemented. In FIG. 2, the SQL engines 15 run as part of the RDBMS 5 which operates as a core database management system that is separate from the independently operating blockchain network 132. That is, the blockchain network 132 operates as a side-system supporting the core database management system 5. This is an example of a form of loose coupling, as described above.

The coupling may achieve at least in part via the commit logic 122, which may be a modified version of existing SQL commit logic. According to the modified commit logic, database transactions are only committed to the DB 110 when the interface layer 124 has confirmed that the corresponding blockchain transaction log record(s) have been recorded on the blockchain 30, i.e. when there is consensus within the blockchain network 132 (in accordance with the consensus protocol 128) that the corresponding blockchain transaction(s) are valid and now form part of the blockchain 30.

Alternatively, the commit logic 122 may commit SQL transactions whether or not the log record is ultimately accepted for embodiment into the blockchain 30. In this way, operation of the commit logic 122 is decoupled from functionality of the blockchain interface layer 124 relating to the output of corresponding log records to the blockchain network 132 and their embodiment in the blockchain 30.

Specific examples in accordance with this architecture will now be described.

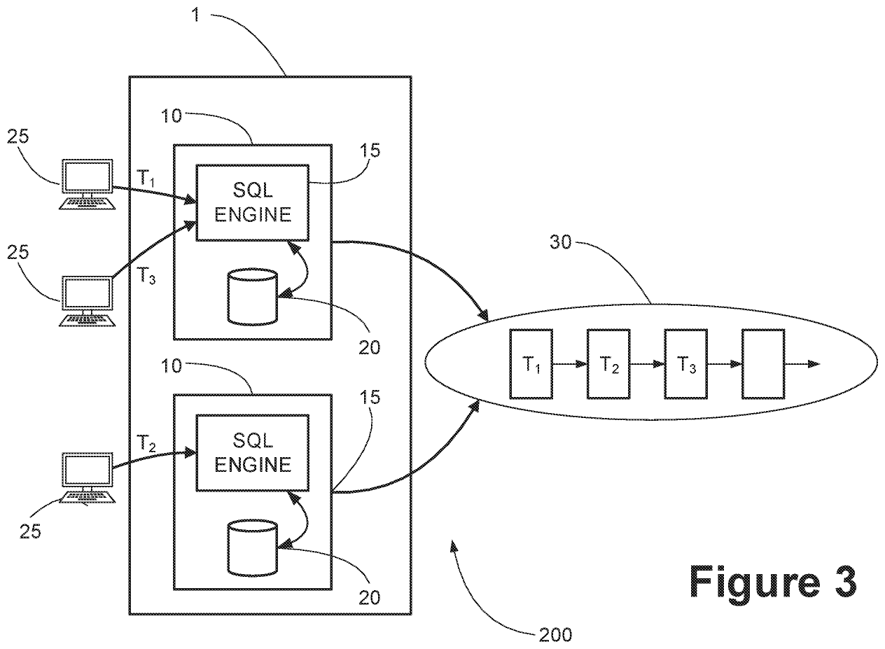

In the described examples, a data processing system is provided by which users may access one or more databases and in which database transactions committed by users may be captured in an immutable audit log embodied in a blockchain. This not only enables insider-attacks or tampering with content of the database or related data to be detected, but also ensures that a state of the database or related data at a particular time can be recovered in the event of compromise. An example data processing system embodying principles of the present invention will now be described with reference to FIG. 3.

Referring to FIG. 3, a schematic block diagram is provided showing components in an example of a data processing computer system 200. In the system 200, is shown to comprise a distributed database system 1 formed of multiple server units 10, which may be geographically distributed. Each of the server units 10 comprises one or more processors, such as CPUs (not shown), on which a respective SQL engine 15 is executed. The SQL engines 15 collectively form part of the RBDMS 5 referred to above. As described above, the SQL engines 15 operate in conjunction to provide a single logical database server, and for that reasons the distributed database system 1 may be referred to as a database server herein.

The server units 10 may be distributed across a plurality of enterprise systems or other systems operated by mutually untrusting entities, i.e. entities which are not assumed to have any relationship of mutual trust.

In this particular example, a SQL engine 15 is provided to process received SQL transactions. By way of example, the processing of received transactions by the SQL engine 15, or other type of transaction processing engine, and RDBMS instance 5 may include one or more of the following:
a. Validating a received transaction execution message from a requesting client 25; for example, to determine whether the SQL text of the message has been validly signed by the requesting client, and/or whether the requesting client 25 is authorized, according to current configuration settings, to instigate a requested database transaction defined by the SQL text. This may be part of a user authentication process, in which a valid signature serves as proof that the message has been instigated by an authorized user (who may be a user to whom a private key needed to generate the signature has been assigned).
b. Executing the requested database transaction, and (where appropriate) committing the database transaction such that the results of is execution become visible to other clients 25.
c. Generating or forwarding, to the requesting client, a response comprising results of the execution or attempted execution of the database transaction. The results may be signed by the SQL instance 15 which executed or attempted to execute that transaction.
d. Generating log data comprising details of the transaction, such the (signed) results of its execution and/or the above response.
e. Outputting the generated log data in a log record, via an associated blockchain interface such as the blockchain interface layer 124 described above, to a blockchain network such as the blockchain network 132 described above, for embodying in a blockchain 30.

Transactions requested by clients 12 of the users of database system 1 are received in this example by the respective SQL engine 15. In this example, transactions T₁ and T₃ are received by one SQL engine from respective users' clients and transaction T₂ is received by a different SQL engine from a respective user's client. Each client is configured cryptographically to sign their requested transaction using a key accessible to the client, assigned to the respective user 25 as an identifier for the user, and which is verifiable using a corresponding public key paired to the private key. It is the intention that any transaction committed for execution in the database that has been cryptographically signed by a user's client and recorded in a log record embodied on the blockchain 30 may be trusted to have taken place and to have originated with the respective user 25.

One or more transactions are included within a log record by the RDBMS instance 5.

A log record includes both the full text of the applicable transaction execution message(s) as signed and submitted by the user's client and results generated in response to the execution/committing the resulting transaction. The log record may also include a transaction sequence number, a timestamp (e.g. date and time), or other indication of the ordering of each transaction relative to other committed and executed transactions included in the log record, for example a date and time of committing the transaction for execution. That is to say, the RBDMS 5 is responsible for defining and imposing an ordering of the transaction log records which may or may not differ from the order in which the corresponding transaction log records are stored in the blockchain 30: the blockchain network 132 may or may not guarantee that log records are embodied in blocks added to the blockchain 30 in the same order as that in which the blockchain interface layer 124 outputs the log records to the blockchain network 132, and this is immaterial as the ordering is defined by the RDBMS itself.

The sequence of transaction log records stored in the blockchain 30, and the ordering of the sequence as defined by the RDBMS 5, defines a persistent state of the database 110 at any point in time, which may be recovered by re-executing each of the recorded database transactions in the order defined by the RDBMS 5 up to that point in time.

A log record including a signed transaction, a response generated following execution of the transaction in the database and sequence ordering data, provides a complete record of a transaction and its effect on the state of, or in respect of the database at that time. As noted, optionally it may also include the write set (insert, update, deletes) where applicable. This enables one of several possible uses of immutable log records embodied in the blockchain 30, for example during use of the database or following compromise or another issue affecting the integrity of the database or its configuration.

A sequence number provides not only an indication of the order in which transactions included in a log record and embodied in the blockchain 30 were executed, but also provides an indication of the completeness of the log record. That is, a missing sequence number indicates that another transaction was executed but not included in a log record output to the blockchain 30. Depending on how sequence numbers are allocated, this may be contingent on aborted transactions also being recorded in the blockchain 30.

FIG. 4 shows an example set of transaction log records 400 stored in the blockchain 30. Each transaction log record 401 comprises a piece of ordering data, which is a sequence number 402 in this example; the full SQL text 404 that defined the original database transaction; at least one client cryptographic signature 406 for verifying the SQL text 404; the results of the execution of the database transaction 408; and at least one server cryptographic signature 410 for verifying the execution results 408. The client cryptographic signature 408 is a signature that was generated from the SQL text 404 by the client 25 that submitted it for execution, using a private key available to the client (which may for example be a private key issued to a particular user who has authenticated with the client 25). The server cryptographic signature 410 is a signature that was generated by the SQL engine 15 that executed the transaction, using a private key available thereto.

The sequence number, timestamp etc. functions as a transaction identifier for identifying the transaction log record to which it applied.

FIG. 5 shows an example data structure of the blockchain 30. The blockchain 30 is shown to be formed of a sequence of blocks. Each block 500 comprises a payload 502, which in turn is shown to comprise a set of transactions 400 of the kind shown in FIG. 4. Additionally the payload 502 of each block 400 (other than a genesis block which is not shown in FIG. 4) contains a pointer 502 to the previous block in the blockchain. The pointer 504 may for example be a hash pointer, computed by hashing data of the previous block.

In this example, the block payload 502 is secured by a block cryptographic signature 506 which can be used to verify the block payload 502, and hence to verify both the set of transaction log records 400 and the block pointer 504 contained in the payload 502. As indicated above, the block signature 506 is generated by a cryptographic signing function 512 executed within a TEE 508 of the blockchain network 132 using a private key 510 held in secure storage of the TEE 508. This cryptographic mechanism operates entirely independently of the database system 1 and the key 510 within the TEE 508 is not accessible within the database system 1 at all, even if it is compromised. The TEE is provided by trusted hardware within the blockchain network 132 and may also be referred to herein as a secure enclave.

In combination, these three cryptographic signatures, i.e. the client signature 406 and the server signature 410 applied, in the database system 1, to each transaction log record 401 in the block payload 502, together with the block signature 506 applied independently within the blockchain network 132, provide a highly robust data verification mechanism for the transaction log records 400, which in turn can be used as a basis for highly robust database auditing.

Whilst FIG. 4 shows a set of three transaction log records, a block payload can contain any number of transaction log records including one.

Moreover, whilst in the example of FIG. 5, the blockchain 30 is secured using cryptographic functions applied within one or more TEEs of the blockchain network 132, the blockchain 30 can be secured in other ways as is known in the art, for example based on proof-of-work requirements etc.

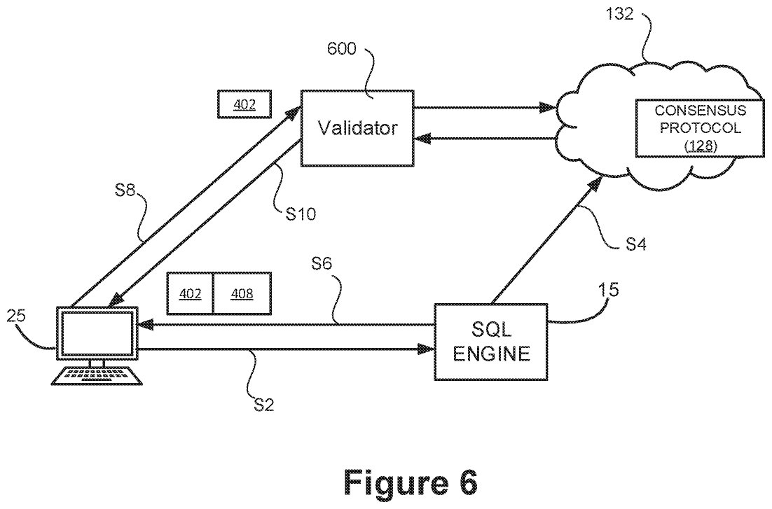

FIG. 6 shows an example signaling diagram for transaction validation process, which allows a client 25 to verify a database transaction by confirming that the corresponding transaction log record has been recorded immutably on the blockchain 30. A transaction log record is said to be immutably stored at the point at which the blockchain network 132 reaches a, in accordance with its consensus protocol 128, that the transaction log record forms part of the state of the blockchain 30. As noted the consensus protocol 128 can take many different forms. The principles of blockchain consensus are well known per se, and are therefore not described in any further detail.

At step S2, the client 25 submits one or more transaction execution messages to the database system 1 and an SQL engine 15 processes those messages to execute a database transaction in response, as above.

At step S4, the SQL engine 15 submits a transaction log record for the database transaction to the blockchain network 132 for storing in the blockchain 30 and, at step S6, returns a set of results of the database transaction execution to the client 25, which in this example match the results 408 that are stored in the blockchain. The storing of the transaction log record S4 can be synchronous or asynchronous, as noted above, hence step S4 may be substantially synchronous with step S6, or step S6 may occur sometime later e.g. as part of a batch process. The SQL engine 15 also provides a transaction of identifier to the client 25 for identifying that transaction log record on the blockchain. In this example, the transaction identifier is the above sequence number 402, but it can be any form of transaction identifier, such as a hash of the transaction log record or the block in which it is stored etc.

At step S10, the client 25 transmits to a validator 600 the transaction log record identifier 402. The validator 600 is a software component executed on a processor, and which has access to the blockchain network 132 but may otherwise operate autonomously. The validator 600 uses the transaction log record identifier 402 received from the client 15 to verify whether or not a matching transaction log record has been stored immutably in the blockchain, and returns the results of that verification process to the client at step S10. Hence the client 25 can determine whether or not the database transaction has been committed to the blockchain 30 as expected.

As noted, a first aspect of the present disclosure provides A database system comprising: computer readable storage media; one or more processors having access to the computer readable storage media and configured to execute a database management system (DBMS) for managing a database embodied in the computer readable storage media; and at least one computer interface configured to receive transaction execution messages relating to the database. The DBMS comprises one or more transaction processing engines configured to execute a series of database transactions, each being executed according to one or more commands received in at least one transaction execution message so as to cause a change of state of the database from a previous state to a new state. The DBMS is configured to generate a series of transaction log records and provide the series of transaction log records to a blockchain network for storing in a blockchain secured by the blockchain network. Each transaction log record corresponds to one of the database transactions and comprises (i) the one or more commands according to which it was executed and (ii) results of its execution, such that the new state of the database is recoverable from that transaction log record and the previous state of the database, whereby the database is fully recoverable from the series of transaction log records stored in the blockchain.

By way of example, optional implementation features that may be implemented in embodiments of the present disclosure are set out below.

The ordering data may comprise sequence numbers and/or timestamps assigned to the transaction log records by the DBMS.

Each transaction log record may comprise a client cryptographic signature for verifying the one or more commands comprised therein, the cryptographic signature having been generated by a source of the at least one transaction execution message in which the one or more commands were received. The source may for example be a client device.

Each transaction log record may comprise a cryptographic signature for verifying the results comprised therein, the cryptographic signature having been generated by the transaction processing engine which executed the database transaction to which the transaction log record relates.

The DBMS may be configured to determine when each transaction log record has been stored immutably in the blockchain according to a consensus protocol of the blockchain network, and only commit, to the database, the corresponding database transaction in response to determining that it has been immutably stored.

The DBMS may be configured to commit each transaction log record to the database independently of the storage of the transaction log record in the blockchain.

The or each transaction processing engine may be configured to interpret the one or more commands in accordance with a database query language.

The database may be a relational database and the database query language may be a Structured Query Language (SQL) for the relational database, the one or more commands taking the form of one or more SQL statements.

Each of the transaction log records may comprise a transaction identifier and the database system may further comprise a validator configured to receive a transaction identifier to be verified and validate the transaction identifier by determining whether it matches the transaction identifier of any transaction log record stored in the blockchain.

Each transaction identifier may be a sequence number or timestamp.

The transaction identifier may be validated by determining whether it matches the transaction identifier of any transaction log record which is determined to have been stored immutably in the blockchain according to a consensus protocol of the blockchain network.

The database may be a relational database.

The blockchain network may operate independently of the DBMS.

The blockchain network may comprise a plurality of trusted execution environments (TEEs) having secure communication channels therebetween. The blockchain containing the transaction log records may be secured by cryptographic processing applied within the TEEs using private cryptographic keys held in secure storage of the TEEs.

The cryptographic processing may comprise cryptographically signing and/or encrypting the transaction log records for storage in the blockchain.

Each database transaction may be executed by performing at least one of the following operations on the database: a data query operation, a data manipulation operation, a data definition operation and data control operation.

The transaction processing engines may be distributed across multiple computing devices operated by mutually untrusted entities.

Another aspect of the present disclosure provides a computer-implemented method of executing a database transaction, the method comprising: receiving, at a transaction processing engine of a database management system (DBMS) at least one transaction execution message relating to a database managed by the DBMS; executing a database transaction, by the transaction processing engine, according to one or more commands comprised in the at least one transaction execution message, wherein the execution of the database transaction causes a change of state of the database from a previous state to a new state; generating a transaction log record comprising (i) results of the execution of the database transaction as generated by the transaction processing engine and (ii) the one or more commands according to which it was executed, such that the new state of the database is recoverable from the transaction log record and the previous state of the database; and providing the transaction log record to a blockchain network, which causes the transaction log record to be stored in a blockchain secured by the blockchain network, wherein the transaction log record forms part of a sequence of transaction log records stored in the blockchain from which the database is fully recoverable.

Any of the above implementation features may be implemented as part of the method.

Another aspect of the present disclosure provides a database management system (DBMS) comprising executable instructions stored on a computer-readable storage medium and configured, when executed one or more processors of a database system, to implement any of the steps disclosed herein.

It is noted that references to code, software, instructions and the like executed one or more processors (or similar) can mean all of the software are executed on the same processor, or that portions of the code can be executed on different processors, which may or may not be co-located. References to “computer storage”, “electronic storage” and any other form of “storage” refer generally to one or more computer-readable storage devices, such as magnetic or solid-state storage devices. For multiple devices, there may or may not be spatially collocated. The features of the techniques described herein are platform-independent, meaning that the techniques may be implemented on a variety of commercial computing platforms having a variety of processors. For example, the systems may include a computer-readable medium that may be configured to maintain instructions that cause the systems, and more particularly any operating system executed thereon and associated hardware of the system to perform operations. Thus, the instructions function to configure the operating system and associated hardware to perform the operations and in this way result in transformation of the operating system and associated hardware to perform functions. The instructions may be provided by the computer-readable medium to the system processor(s) through a variety of different configurations. One such configuration of a computer-readable medium is signal-bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A database system comprising:
computer readable storage media;
one or more processors having access to the computer readable storage media and configured to execute a database management system (DBMS) for managing a database embodied in the computer readable storage media; and
at least one computer interface configured to receive transaction execution messages relating to the database;
wherein the DBMS comprises one or more transaction processing engines configured to execute a series of database transactions, each being executed according to one or more commands received in at least one transaction execution message so as to cause a change of state of the database from a previous state to a new state;
wherein the DBMS is configured to generate a series of transaction log records and provide the series of transaction log records to a blockchain network for storing in a blockchain secured by the blockchain network;
wherein each transaction log record corresponds to one of the database transactions and comprises (i) the one or more commands according to which it was executed and (ii) results of its execution, such that the new state of the database is recoverable from that transaction log record and the previous state of the database, whereby the database is fully recoverable from the series of transaction log records stored in the blockchain.

2. The database system according to claim 1, wherein the series of transaction log records comprises ordering data generated by the DBMS, which define a relative order of execution for the database transactions.

3. The database system according to claim 2, wherein the ordering data comprises sequence numbers and/or timestamps assigned to the transaction log records by the DBMS.

4. The database system according to claim 1, wherein each transaction log record comprises a client cryptographic signature for verifying the one or more commands comprised therein, the cryptographic signature having been generated by a source of the at least one transaction execution message in which the one or more commands were received.

5. The database system according to claim 4, wherein the source is a client device.

6. The database system according to claim 1, wherein each transaction log record comprises a cryptographic signature for verifying the results comprised therein, the cryptographic signature having been generated by the transaction processing engine which executed the database transaction to which the transaction log record relates.

7. The database system according to claim 1, wherein the DBMS is configured to determine when each transaction log record has been stored immutably in the blockchain according to a consensus protocol of the blockchain network, and only commit, to the database, the corresponding database transaction in response to determining that it has been immutably stored.

8. The database system of claim 1, wherein the DBMS is configured to commit each transaction log record to the database independently of the storage of the transaction log record in the blockchain.

9. The database system according to claim 1, wherein the or each transaction processing engine is configured to interpret the one or more commands in accordance with a database query language.

10. The database system according to claim 9, wherein the database is a relational database and the database query language is a Structured Query Language (SQL) for the relational database, the one or more commands taking the form of one or more SQL statements.

11. The database system according to claim 1, wherein each of the transaction log records comprises a transaction identifier and the database system further comprises a validator configured to receive a transaction identifier to be verified and validate the transaction identifier by determining whether it matches the transaction identifier of any transaction log record stored in the blockchain.

12. The database system of claim 11, wherein each transaction identifier is a sequence number or timestamp.

13. The database system of claim 11, wherein the transaction identifier is validated by determining whether it matches the transaction identifier of any transaction log record which is determined to have been stored immutably in the blockchain according to a consensus protocol of the blockchain network.

14. The database system according to claim 1, wherein the database is a relational database.

15. The database system according to claim 1, wherein the blockchain network comprises a plurality of trusted execution environments (TEEs) having secure communication channels therebetween, wherein the blockchain containing the transaction log records is secured by cryptographic processing applied within the TEEs using private cryptographic keys held in secure storage of the TEEs.

16. The database system according to claim 15, wherein the cryptographic processing comprises cryptographically signing or encrypting the transaction log records for storage in the blockchain.

17. The database system according to claim 1, wherein each database transaction is executed by performing at least one of the following operations on the database: a data query operation, a data manipulation operation, a data definition operation and data control operation.

18. The database system according to claim 1, wherein the transaction processing engines are distributed across multiple computing devices operated by mutually untrusted entities.

19. A computer-implemented method of executing a database transaction, the method comprising:
receiving, at a transaction processing engine of a database management system (DBMS) at least one transaction execution message relating to a database managed by the DBMS;
executing a database transaction, by the transaction processing engine, according to one or more commands comprised in the at least one transaction execution message, wherein the execution of the database transaction causes a change of state of the database from a previous state to a new state;
generating a transaction log record comprising (i) results of the execution of the database transaction as generated by the transaction processing engine and (ii) the one or more commands according to which it was executed, such that the new state of the database is recoverable from the transaction log record and the previous state of the database; and
providing the transaction log record to a blockchain network, which causes the transaction log record to be stored in a blockchain secured by the blockchain network, wherein the transaction log record forms part of a sequence of transaction log records stored in the blockchain from which the database is fully recoverable.

20. A database management system (DBMS) comprising executable instructions stored on a computer-readable storage medium and configured, when executed one or more processors of a database system, to implement the following operations:
receiving, at a transaction processing engine of the DBMS at least one transaction execution message relating to a database managed by the DBMS;
executing a database transaction, by the transaction processing engine, according to one or more commands comprised in the at least one transaction execution message, wherein the execution of the database transaction causes a change of state of the database from a previous state to a new state;
generating a transaction log record comprising (i) results of the execution of the database transaction as generated by the transaction processing engine and (ii) the one or more commands according to which it was executed, such that the new state of the database is recoverable from the transaction log record and the previous state of the database; and
providing the transaction log record to a blockchain network, which causes the transaction log record to be stored in a blockchain secured by the blockchain network, wherein the transaction log record forms part of a sequence of transaction log records stored in the blockchain from which the database is fully recoverable.
